(19) United States
(12) Patent Application Publication
(10) Pub. No.: US 2023/0345910 A1
(43) Pub. Date: Nov. 2, 2023

(54) DOG RAINCOAT WITH A REMOVABLE BELLY PIECE

(71) Applicant: Petra Margareta Martensson, Sausalito, CA (US)

(72) Inventor: Petra Margareta Martensson, Sausalito, CA (US)

(21) Appl. No.: 17/891,867

(22) Filed: Aug. 19, 2022

Related U.S. Application Data
(60) Provisional application No. 63/337,126, filed on May 1, 2022.

(51) Int. Cl. A01K 13/00

(52) U.S. Cl. CPC A01K 13/006

(57) ABSTRACT

A multi-part, waterproof, windproof, hooded, reflective and wearable tech/monitoring dog raincoat with a removable belly piece is disclosed. A dog raincoat comprises, a multi-part body portion that covers and extends from the back rear end to a head of a dog, and the underside of the dog in a concave formation. The underside portion is a removable belly piece that substantially covers the belly and chest of the dog. The dog raincoat comprises; a waterproof, windproof foldable hood attached to the top/front body portion of the dog raincoat to cover and uncover the head of the dog. The dog raincoat further comprises fastening structures for fastening the body portion to the removable belly piece and securing the raincoat to the dog.

### BACKGROUND OF THE INVENTION

When a dog goes for walks during inclement weather conditions, such as rain or snow, it will likely get wet and muddy on its belly and chest from stepping in puddles and kicking up water and dirt as it walks. This forces the dog owner/walker to clean the dog's underside. If the dog wears a traditional dog raincoat, the dog owner/walker will have to clean and wash the entire garment and still have problems associated with the underside of the dog being wet and muddy. Although there are variations of raincoats for dogs that exist in today's retail market, there remains a need for an improved, utilitarian and modular dog raincoat that is efficient and user friendly for the dog owner/walker when it comes to functionality and cleaning process.

Thus, there is a need in the field of dog raincoats for a garment that offers an easier, more efficient and sustainable way of cleaning the most often dirtiest part of the dog raincoat—the underside portion covering the dog's belly and chest—without having to clean the entire garment. There is a need for a swift and modular solution that offers dog owners/walkers ease, cleanliness, time efficiency, and simplicity, all while being functional, comfortable and protective for the dog.

### SUMMARY OF THE INVENTION

The invention relates to outerwear garments for dogs that protect against inclement weather and wet conditions on the ground outdoors. More specifically, the dog garment comprises a removable belly piece that attaches and detaches to the underside of the garment. The whole dog garment is a dog raincoat that is made from waterproof and windproof materials. The raincoat covers a dog's body, head, and underside. The raincoat does not cover a dog's legs and face. It also does not cover the dog's rump and genitals, so a dog may go to the bathroom during its walks without hindrance.

In one embodiment, a dog raincoat comprises a multi-part body portion that covers and extends from the back rear end to a head of a dog and the underside of the dog in a concave formation. The underside portion of the dog raincoat comprises a removable belly piece that covers the belly and chest of the dog. The dog raincoat comprises fasteners for fastening the body portion to the removable belly piece and securing the dog raincoat to the dog. The fasteners include a fastening loop located on the front chest part of the outside of the dog raincoat body for fastening the top of the removable belly piece to the chest area. The fastening loops outside the dog raincoat body are located on the left and right sides for fastening the removable belly piece to the left and right sides. In one embodiment, the fasteners include a fastening loop located on the front chest part of the outside of the dog raincoat body for fastening the top of the removable belly piece to the chest area, wherein the fastening loops outside the dog raincoat body are located on the left and right sides for fastening the removable belly piece to the left and right sides.

One embodiment is directed to a dog raincoat comprising a multi-part body portion that covers and extends from the back rear end to a head of a dog and the underside of the dog in a concave formation, wherein the underside portion is a removable belly piece that covers the belly and chest of the dog, and fasteners for fastening the body portion to the removable belly piece and securing the raincoat to the dog. The removable belly piece is, in one example, a waterproof, windproof, reflective piece that may attach to the body portion or detach completely from the body portion of the dog raincoat. The removable belly piece may further comprise a reflective edge bias binding. The removable belly piece, in one example, further comprises fastening hooks on the top, left and right sides for fastening the removable belly piece to the body portion of the dog raincoat using a hook and loop fastening technique.

Another aspect of the disclosure is directed to a dog raincoat comprising a multi-part body portion that covers and extends from the back rear end to a head of a dog and the underside of the dog in a concave formation, wherein the underside portion is a removable belly piece that covers the belly and chest of the dog; fastening structures for fastening the body portion to the removable belly piece and securing the dog raincoat to the dog; and a hood that is a waterproof, windproof, foldable hood, attached to the top/front body portion of the dog raincoat to cover and uncover the head of the dog.

In one embodiment, an exterior portion of the body portion is made of a waterproof and windproof material, including any one of recycled polyester (rPET), a Biopolymer or any other appropriate waterproof and windproof materials. Further, an interior portion of the body portion is made of fleece or any other soft material for the interior of the dog raincoat. In one embodiment, the dog raincoat comprises a hole in the upper front center body portion for the collar or harness of a dog. In one embodiment, the dog raincoat comprises a right back leg rubber band on the bottom right inside of the dog raincoat body to hold the dog raincoat in place in the rear. In one embodiment, the dog raincoat comprises a left back leg rubber band on the bottom left inside of the dog raincoat body to hold the dog raincoat in place in the rear.

In one embodiment, the removable belly piece further comprises a reflective edge bias binding. The removable belly piece further comprising fleece or any other soft material for the interior portion of the removable belly piece. The removable belly piece further comprising fastening hooks on the top, left and right sides for fastening the removable belly piece to the body portion of the dog raincoat using a hook and loop fastening technique. The removable piece is, in one example, a waterproof, windproof, reflective belly piece that may attach to the body portion or detach completely from the body portion of the dog raincoat.

In another embodiment, a dog raincoat comprises a multi-part body portion that covers and extends from the back rear end to a head of a dog and the underside of the dog in a concave formation, the underside portion of the dog raincoat comprises a removable belly piece that covers the belly and chest of the dog. The dog raincoat comprises a hood that can cover the head of the dog. In one example, the hood is made of a waterproof, windproof foldable material and is attached to the top/front body portion of the dog raincoat. The dog raincoat comprises fasteners for fastening the body portion to the removable belly piece and securing the raincoat to the dog. The removable belly piece is a waterproof, windproof, reflective piece that may attach to the body portion or detach completely from the body portion of the dog raincoat.

In one embodiment, the disclosure is directed to a dog raincoat comprising a) a multi-part body portion that covers and extends from the back rear end to a head of a dog and the underside of the dog in a concave formation, wherein the underside portion is a removable belly piece that covers the belly and chest of the dog, and b) hook and loop fasteners for fastening the body portion to the removable belly piece and securing the raincoat to the dog.

In one embodiment, the hood further comprises an external material made of recycled polyester (rPET), a Biopolymer, or any other waterproof and windproof materials. The hood further comprises an internal material made of fleece or any other soft material for the inside of the hood. The dog raincoat further comprises a reflective edge bias binding outlining the front edge of the hood, all edges of the body portion, and all edges of the removable belly piece. The dog raincoat further comprises a reflective piping between the hood and body portion to increase visibility and safety for the dog.

The external waterproof and windproof materials protect most of a dog's body from a multitude of conditions, including precipitation, puddles, and wet or muddy grounds. The external protective material may be made of recycled polyester (rPET), a Biopolymer, or any other appropriate waterproof and windproof materials.

The dog raincoat has a hood attached to the body portion that may be folded downwards towards the neck of a dog or unfolded upwards to cover the head of a dog. The removable belly piece may be fastened to the body portion of the dog raincoat by pieces of hook on the top, left and right sides of the removable belly piece, and pieces of loop on the left and right sides of the mid portion on the body portion, and on the front side of the chest portion of the dog raincoat. In one embodiment, there is a loop on the body portion, and a hook on the belly piece. In one embodiment, as well as having a removable belly piece, the dog raincoat may also have included wearable technological solutions such as a Bluetooth or other digital tracking/detecting solutions (GPS), which is useful if the dog were to get lost.

Given a dog needs to go out and urinate and defecate multiple times per day, it's highly efficient and convenient for the dog owner/walker to quickly and easily be able to detach just the removable belly piece to clean it, instead of the whole garment, or swap the wet, soiled removable belly piece for a new, dry removable belly piece. This modular construction makes the present invention unique in its functionality.

In one embodiment, the disclosure is directed to a dog raincoat, comprising a multi-part body portion that covers and extends from the back rear end to a head of a dog and the underside of the dog in a concave formation, wherein the underside portion is a removable belly piece that covers the belly and chest of the dog, wherein the removable belly piece is a waterproof, windproof, reflective belly piece that may attach to the body portion or detach completely from the body portion of the dog raincoat using a hook and loop fastening technique.

### BRIEF DESCRIPTION OF THE DRAWINGS

FIG. 1 illustrates a front left side perspective view of the dog raincoat modeled by a dog in a seated position;

FIG. 2 illustrates a left side view of the dog raincoat modeled by a dog in a seated position;

FIG. 3 illustrates a right side view of the dog raincoat modeled by a dog in a standing position;

FIG. 4 illustrates a top view of the entire dog raincoat with the removable belly piece fastened to the body of the dog raincoat;

FIG. 5 illustrates a view from below of the entire dog raincoat with the removable belly piece fastened to the body of the dog raincoat;

FIG. 6 illustrates a flat outside view of the hood with reflective edge bias binding outlining the front edge and reflective piping between the hood and the dog raincoat body;

FIG. 7 illustrates an outside flat view of the body of the dog raincoat with fastening loop located on the front left and right sides of the chest, fastening loop for the removable belly piece on the left and right sides of the mid portion of the body portion, a collar/harness hole in the upper front center, and a logotype patch in the rear back end;

FIG. 8 illustrates a flat inside view of the hood with reflective edge bias binding outlining the front edge and reflective piping between the hood and the dog raincoat body;

FIG. 9 illustrates an inside flat view of the body of the dog raincoat with a collar/harness hole in the upper center and rubber bands on the left back leg and right back leg to hold the dog raincoat in place in the rear;

FIG. 10 illustrates an outside view of the removable belly piece with a reflective edge bias binding outlining all edges of the removable belly piece; and

FIG. 11 illustrates an inside view of the removable belly piece with reflective edge bias binding outlining all edges of the removable belly piece and fastening hooks for attaching the removable belly piece to the front, left, and right sides of the body of the dog raincoat.

### DETAILED DESCRIPTION

The present invention relates to outerwear garments for pets, such as dogs. More specifically, the invention relates to a waterproof and windproof raincoat for a dog. The invention particularly relates to a removable belly piece that detaches from an outdoor, waterproof, windproof, hooded, reflective and wearable tech/monitoring dog garment. Although the invention is designed to be useful for many different animals, it is principally directed to dogs and will be exclusively referred to hereafter solely for giving an example.

Dogs get wet and dirty on their bellies from walking outside in the rain, mud, and other elements of the outdoors or other types of inclement weather. The traditional garments and apparel that exist in today's dog retail market do not offer an efficient, flexible, modular solution to the prevalent problem of easily cleaning or replacing the part that most often gets the dirtiest; the belly piece portion. Since the existing dog raincoats in the retail market do not come fully apart in detachable pieces, the dog owner/walker has to wash the entire garment each time which is highly inefficient and time, energy and water wasting.

With a removable belly piece, the dog owner/walker simply detaches the wet and dirty removable belly piece from the body of the dog raincoat after the outdoor walk. The dog owner/walker then cleans or replaces the wet and usually soiled removable belly piece with a new, dry removable belly piece. This quick and modular solution offers dog owners/walkers ease, cleanliness, time efficiency, and simplicity. It also contributes to environmental sustainability since the whole garment does not need to be washed after every single use, hence minimizes the amount of water, energy and detergent needed.

One aspect of the disclosure is directed to a dog raincoat, comprising a multi-part body portion that covers and extends from the back rear end to a head of a dog and the underside of the dog in a concave formation, wherein the underside portion is a removable belly piece that covers the belly and chest of the dog, wherein the removable belly piece is a waterproof, windproof, reflective piece that may attach to the body portion or detach completely from the body portion of the dog raincoat. In another example, the disclosure is directed to a dog raincoat comprising a multi-part body portion that covers and extends from the back rear end to a head of a dog and the underside of the dog in a concave formation, wherein the underside portion is a removable belly piece that covers the belly and chest of the dog; and fastening structures for fastening the body portion to the removable belly piece and securing the raincoat to the dog; and a hood that is a waterproof, windproof foldable hood, and is attached to the top/front body portion of the dog raincoat to cover and uncover the head of the dog.

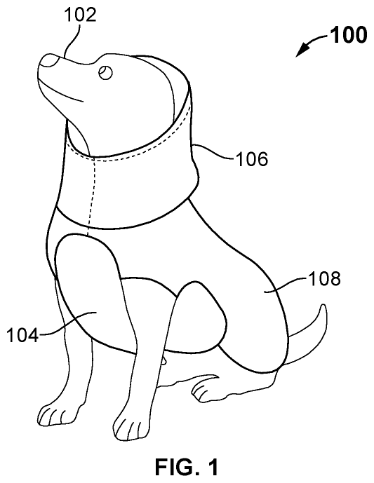

The present invention relates generally to a dog raincoat that is waterproof, windproof, hooded, and reflective with a wearable tech/monitoring system that has a removable belly piece. FIG. 1 illustrates a front left side perspective view of the dog raincoat 100 modeled by a dog 102 in a seated position. A dog raincoat 100 comprises a multi-part body portion 108 that covers and extends from the back rear end to a head of a dog 102 and the underside of the dog 102 in a concave formation. The underside portion of the dog raincoat comprises a removable belly piece 104 that covers the belly and chest of the dog 102. The dog raincoat 100 comprises a hood 106, which is a waterproof, windproof foldable hood attached to the top/front body portion of the dog raincoat 100 to cover and uncover the head of the dog 102.

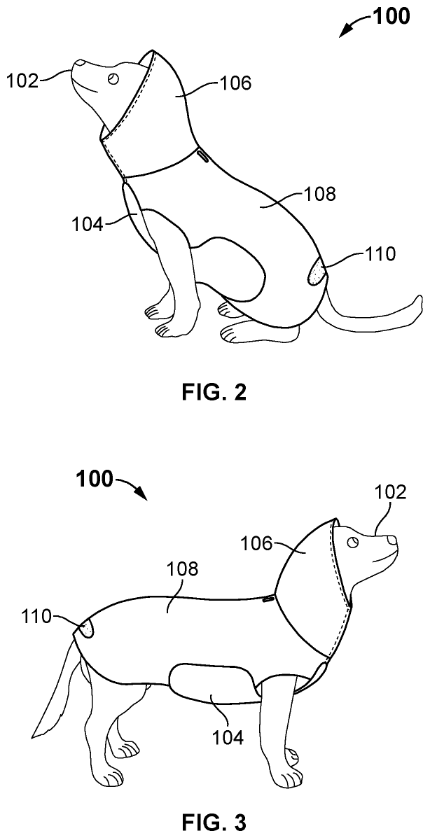

FIG. 2 illustrates a left side view of the dog raincoat 100 modeled by a dog in a seated position. FIGS. 1 & 2 show the dog raincoat in its entirety with the removable belly piece 104 attached from the left and front side point of view with a dog 102 in a sitting position. FIG. 3 illustrates a right side view of the dog raincoat modeled by a dog in a standing position. Furthermore, FIGS. 2 & 3 show where the placement of the logo patch 110 will be. The logo patch 110 will be positioned in the middle rear portion on the outside of the dog raincoat body 108. FIG. 3 shows the entire dog raincoat 100 with the removable belly piece 104 attached from the right side point of view with a dog 102 in a standing position.

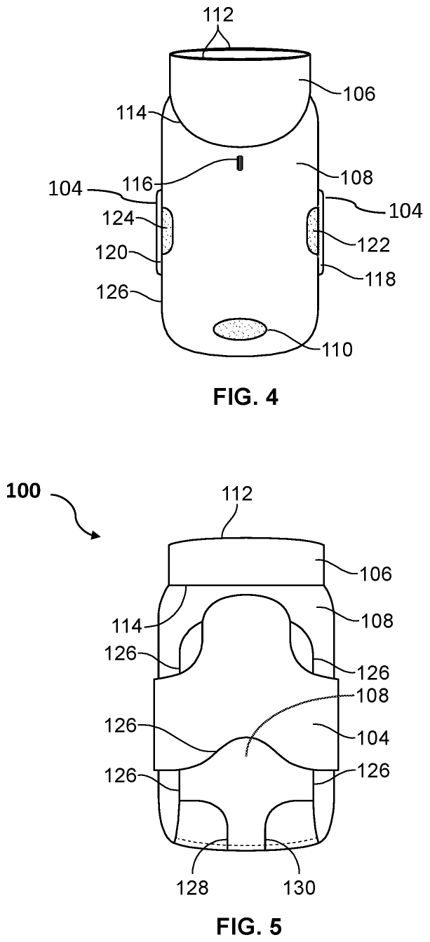

FIG. 4 illustrates a top view of the entire dog raincoat 100 with the removable belly piece 104 fastened to the body 108 of the dog raincoat 100. FIG. 5 illustrates a view from below (underneath) of the entire dog raincoat 100 with the removable belly piece 104 fastened to the body of the dog raincoat 100. FIG. 4 & FIG. 5 illustrate how the removable belly piece 104 fastens on the right side 118 and the left side 120 of the dog raincoat body 108. FIG. 5 depicts the underpart of the dog raincoat body 108 fully attached to the removable belly piece 104.

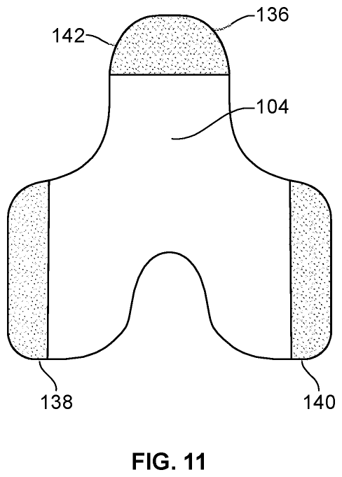

By using hook and loop fasteners, the dog owner/walker may quickly and easily attach and detach the removable belly piece 104 in a flexible way that will provide a comfortable fit for a dog 102, while ensuring the whole garment is secured onto a dog's body. The loops (122 & 124) on the left and right sides of the dog raincoat 108, align with the ribcage area of a dog 102, and are sizable enough to allow the dog owner/walker to adjust the fastening of the hooks (136, 138 & 140) as shown in FIG. 11, on the removable belly piece 104 according to the size, and comfort of a dog 102. The dog owner/walker can fasten the removable belly piece 104 either higher or lower on the dog raincoat body 108 to comfortably fit a dog's body, especially the lower chest and upper belly area. This allows for more flexibility and range in fitting dogs of different breeds and sizes rather than a one size fits all approach. The removable belly piece only covers a small part of the abdominal area, but all of the chest and upper belly area.

FIG. 5 illustrates the flat view of the bottom (underside) portion of the dog raincoat body 108. To secure the dog raincoat 100 in place in the rear, there is a left back leg rubber band 128 attached to the bottom left inside of the dog raincoat body 108 by conventional stitching. The left back leg rubber band 128 holds the dog raincoat body 108 in place in the rear by being secured around a dog's left back leg. There is also a right back leg rubber band 130 attached to the bottom right inside of the dog raincoat body 108 by conventional stitching. The right back leg rubber band 130 holds the dog raincoat body 108 in place in the rear by being secured around a dog's right back leg. The soft rubber band material allows a dog 102 to be comfortable while also securing the rear portion of the dog raincoat body 108. The back leg rubber bands (128, 130) are thin and can stretch to easily fit different breeds and different sized dogs 102 in a comfortable way.

The outside of the dog raincoat body 108 and hood 106 may be made of recycled polyester (rPET), a Biopolymer, or any other appropriate waterproof and windproof materials that would protect a dog's fur from rain, mud, and other elements of the outdoors or other types of inclement weather. A waterproof and windproof material on the outside of the dog raincoat body 108 and the hood 106 keeps any precipitation, dirt, or other outside remnants from seeping through the dog raincoat and onto a dog's fur or skin. The inside of the dog raincoat body 108 and hood 106 may be made from fleece or any other appropriate soft material to provide comfort to the body of a dog 102.

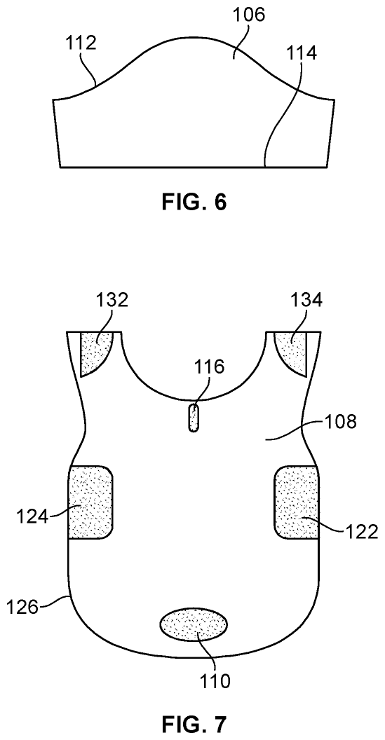

FIG. 6 illustrates a flat outside view of the hood 106 with reflective edge bias binding 112 outlining the front edge and reflective piping 114 between the hood 106 and the dog raincoat body 108. The reflective edge bias binding 112 that outlines the front of the hood 106 improves visibility and safety of a dog 102 wearing the dog raincoat 100. FIG. 6 also illustrates the reflective piping 114 that is between the hood 106 and the dog raincoat body 108. The hood 106 is fixedly attached to the top/front of the dog raincoat body 108 by conventional stitching. The reflective piping 114 increases and enhances visibility and safety of a dog 102 wearing the dog raincoat 100. The reflective edge bias binding 112 and reflective piping 114 both enhance the visibility of a dog 102, especially in situations where it is dark, rainy, foggy or where vision is impaired.

FIG. 7 illustrates an outside flat view of the body 108 of the dog raincoat 100 with fastening loops (132 & 134) for the removable belly piece located on the front left and right areas of the chest, fastening loops (122 & 124) for the removable belly piece on the left and right sides of the mid portion on the body portion, a collar/harness hole 116 on the upper front center area, and a logotype patch 110 on the center rear area. The body 108 of the dog raincoat 100 may cover most of a dog's body, including the length of its back and left and right sides, in a concave formation. The body 108 of the dog raincoat 100 will wrap comfortably and snug around a dog 102 allowing the dog 102 to move freely and adequately.

The dog raincoat 100 will also protect a dog's fur from rain, mud, and other elements of the outdoors or other types of inclement weather. FIG. 7 also illustrates the reflective edge bias binding 126 that outlines the entire dog raincoat body 108. The reflective edge bias binding 126 increases visibility and safety for a dog 102 because it makes the entire dog raincoat 100 easier to see. The reflective edge bias binding 126 is particularly useful when a dog 102 is outside in the dark or during any kind of weather conditions which reduce overall visibility. When visibility is reduced there is a greater risk of vehicles (cars, motorcycles, mopeds, bicycles, etc.) accidentally coming into contact with dogs of all sizes. Since the reflective edge bias binding 126 will make a dog 102 much more visible, it greatly increases the safety of both the dog 102 and the dog owner/walker. In one example, the hood 106 of the dog raincoat 100 is comprised of an external material made of recycled polyester (rPET), a Biopolymer, or any other waterproof and windproof materials, and outlined with a reflective front edge bias binding 126. The internal material of the hood 106 may be made of fleece or any other equivalent soft material for the inside of the hood 106.

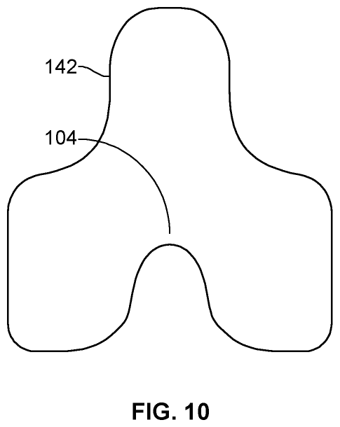

The body 108 of the dog raincoat 100 may contain a collar/harness hole 116 so that a dog owner/walker may nimbly and easily attach a dog's leash to the collar or harness under the dog raincoat 100. The collar/harness hole 116 is placed on the upper front center portion of the dog raincoat body 108. The hole goes through the garment, in one embodiment. The body 108 may also contain a pocket or insert where the dog owner/walker may place digital tracking or GPS technology in order to track a dog's movements and geographical position if need be. FIG. 7 also depicts a loop 132 on the left front side of the outside portion of the dog raincoat body 108. On the right front side of the outside portion of the dog raincoat body 108 there is also a loop 134. Both loops (132 & 134), sewn together as one, have the purpose of fastening the top hook 136 on the removable belly piece 104 so that it attaches to the front chest portion of the dog raincoat body 108. FIG. 7 also illustrates a loop 124 on the mid left side of the outside portion of the dog raincoat body 108. There is also a loop 122 on the mid right side of the outside portion of the dog raincoat body 108. Both loops (122 & 124) have the purpose of fastening the hooks (138 & 140) to either side of the dog raincoat body 108 by the center ribcage area of a dog 102 (see also FIGS. 10 & 11). When the removable belly piece 104 (as shown in FIGS. 10 & 11) is attached to the body of the dog raincoat 100, a dog's underside, including belly and chest area, will also be substantially covered, and a dog's fur will be protected from dirt, rain, or any other imposing material on the dog 102.

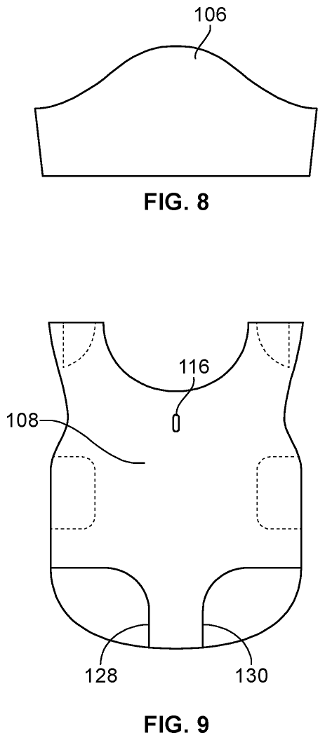

FIG. 8 illustrates a flat inside view of the hood 106. The inside of the hood 106 is made of fleece or any other appropriate soft material. Both the outside and inside materials of the hood 106 are flexible and allow a dog owner/walker to fold down the hood 106 so that it is not covering over the dog's head but is rather folded down to the neck of the dog 102. A dog owner/walker may also unfold the hood 106 over a dog's head to shield it from rain, snow, sleet, hail, or any other inclement weather conditions.

FIG. 9 illustrates an inside flat view of the body 108 of the dog raincoat 100 with a collar/harness hole 116 positioned in the upper front center area, and rubber bands (128 & 130) on the left back leg and right back leg to hold the rear of the dog raincoat 100 in place. As shown in FIGS. 2 & 3, the hood 106 may be unfolded and cover a dog's head. The hood 106 may also be folded down to the neck of the dog 102 and adjusted to the dog's general comfort and weather conditions.

FIG. 10 illustrates an outside view of the removable belly piece 104 with a reflective edge bias binding 142 outlining the removable belly piece 104. The removable belly piece 104 detaches from the outside body of the dog raincoat 100 (as shown in FIG. 2). The outside of the removable belly piece 104 is the part of the dog raincoat 100 that often gets the dirtiest from rain, mud, and other elements of the outdoors or other types of inclement weather. After the dog's walk, the dog owner/walker may detach the removable belly piece 104 from the dog raincoat body 108 by unhooking the hooks (136, 138 & 140) from their fastenings. The dog owner/walker can then clean just the removable belly piece 104 or replace it with another dry, clean removable belly piece 104. The removable belly piece 104 may further comprise fleece, or any other equivalent soft material for the interior portion of the removable belly piece 104. In one example, the removable belly piece 104 is comprised of fastening hooks (136, 138, 140) on the top, left and right sides for fastening the removable belly piece 104 to the body portion 108 of the dog raincoat 100 using a hook and loop fastening technique.

FIG. 10 also shows that the removable belly piece 104 of the dog raincoat 100 is configured to cover the majority of the underside of the dog 102, to wrap around its left and right sides, and attach to the outside body 108 of the dog raincoat 100 (as shown in FIG. 2). The removable belly piece 104 provides significant coverage to the underside of the dog 102, and prevents the dog's fur from getting wet and dirty since it keeps it from being exposed, protecting it when the dog raincoat 100 is worn. Additionally, the coverage of the underside allows the dog 102 to urinate and defecate comfortably without constraints. The outside of the removable belly piece 104 is made from recycled polyester (rPET), a Biopolymer, or any other appropriate waterproof and windproof materials. The outside of the removable belly piece 104 is made with such material to ensure that any water, rain, mud, or other elements does not come into contact with the fur or skin of a dog 102. The dog owner/walker can choose whether to wipe away such elements quickly or to fully wash and sanitize the removable belly piece 104 of the garment. By significantly reducing the amount of material needed to be continually washed when soiled, the dog raincoat 100 is highly sustainable due to the reduced amount of water, energy and detergent used to clean the dog raincoat 100 at any given time.

FIG. 11 illustrates an inside view of the removable belly piece 104 with reflective edge bias binding 142 outlining the removable belly piece 104 and fastening hooks (136, 138 & 140) for attaching the removable belly piece 104 to the front, left, and right sides of the body 108 of the dog raincoat 100. The inside portion of the removable belly piece 104 may be comprised of material like fleece or any other appropriate soft material to provide comfort to a dog's body. Also, this material is used on the inside of the removable belly piece 104 because it protects the dog's fur and skin against any kind of abrasions. This particular inside material is not waterproof or water-repellant hence providing less protection against water, rain and other types of inclement outdoor weather. In other embodiments, the inside material may be waterproof or water-repellant so as to not absorb any water if it becomes wet.

FIG. 11 also illustrates the inside view of the removable belly piece 104, which attaches to the outside body of the dog raincoat 100 (as shown in FIG. 2) by hook and loop fasteners. Further, FIG. 11 illustrates the left inside of the removable belly piece 104 where there is a hook 138 that fastens to the left side of the dog raincoat body 108 by hook and loop fastening technique. On the right inside of the removable belly piece 104 there is a hook 140 that fastens to the right side of the dog raincoat body 108 by hook and loop fastening technique. The dog raincoat body may further comprise a reflective edge bias binding 126 outlining the front edge of the hood 106, all edges of the body portion 108, and all edges of the removable belly piece 104. In a particular embodiment, the reflective edge bias binding 126 outlines a) the front edge of the hood 106, b) all edges of the body portion 108 and c) all edges of the removable belly piece 104. The dog raincoat 100 may further comprise a reflective piping 114 between the hood 106 and body portion 108 to increase visibility and safety.

Advantageously, the removable belly piece 104 allows the owner/walker of the dog 102 to quickly and easily detach and clean only the removable belly piece 104, which is the part of a dog raincoat that most often gets dirty from walking in the rain, mud, or other elements of the outdoors. Rather than having to wash the entire dog raincoat 100, the dog owner/walker can simply detach the removable belly piece 104 and either wash it, or replace it with a new, dry removable belly piece 104. Another advantage of the present invention is its environmentally conscious nature. In particular, due to its modular construction and function, it is a highly environmentally sustainable product due to the reduced amount of water, energy and detergent that is needed to clean just the removable belly piece, instead of the entire dog raincoat. Simultaneously, this modular construction and function provides an efficient, easy and quick process, making it very convenient for the dog owner/walker.

In one example, the disclosure is directed to a dog raincoat comprising a multi-part body portion that covers and extends from the back rear end to a head of a dog and the underside of the dog in a concave formation, wherein the underside portion is a removable belly piece that substantially covers the belly and chest of the dog; fastening structures for fastening the body portion to the removable belly piece and securing the dog raincoat to the dog; and a hood that is a waterproof, windproof foldable hood, attached to the top/front body portion of the dog raincoat to cover and uncover the head of the dog.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method, function and construction in a certain order does not constitute any limitation on the order of the steps of that method, function and construction.

Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein. While the above is a complete description of the preferred embodiments of the invention, unlimited alternatives, modifications, and equivalents may be used. Therefore, the above description and the examples should not be taken as limiting the scope of the invention, which is defined by the appended claims.

1. A dog raincoat comprising:
a multi-part body portion that covers and extends from the back rear end to a head of a dog and the underside of the dog in a concave formation, wherein the underside portion is a removable belly piece that substantially covers the belly and chest of the dog, and hook and loop fasteners for fastening the body portion to the removable belly piece and securing the dog raincoat to the dog.

2. The dog raincoat of claim 1, wherein the fasteners include a fastening loop located on the front chest part of the outside of the dog raincoat body for fastening the top of the removable belly piece to the chest area, wherein the fastening loops outside the dog raincoat body are located on the left and right sides for fastening the removable belly piece to the left and right sides.

3. The dog raincoat of claim 1, wherein an exterior portion of the body portion is made of a waterproof and windproof material, including any one of a recycled polyester (rPET), a Biopolymer or any other appropriate waterproof and windproof materials, outlined by a reflective edge bias binding.

4. The dog raincoat of claim 1, wherein an interior portion of the body portion is made of fleece or any other equivalent soft material for the interior of the dog raincoat.

5. The dog raincoat of claim 1, further comprising a hole in the upper front center area of the body portion for the collar or harness of a dog.

6. The dog raincoat of claim 1, further comprising a right back leg rubber band on the bottom right inside of the dog raincoat body to hold the dog raincoat in place in the rear.

7. The dog raincoat of claim 1, further comprising a left back leg rubber band on the bottom left inside of the dog raincoat body to hold the dog raincoat in place in the rear.

8. A dog raincoat, comprising:
a multi-part body portion that covers and extends from the back rear end to a head of a dog and the underside of the dog in a concave formation, wherein the underside portion is a removable belly piece that substantially covers the belly and chest of the dog, wherein the removable belly piece is a waterproof, windproof, reflective belly piece that may attach to the body portion or detach completely from the body portion of the dog raincoat using a hook and loop fastening technique.

9. A removable belly piece of claim 8, further comprising an external material made of recycled polyester (rPET), a Biopolymer, or any other appropriate waterproof and windproof materials, outlined by a reflective edge bias binding.

10. A removable belly piece of claim 8, further comprising fleece or any other equivalent soft material for the interior portion of the removable belly piece.

11. A removable belly piece of claim 8, further comprising fastening hooks on the top, left and right sides for fastening the removable belly piece to the body portion of the dog raincoat using a hook and loop fastening technique.

12. A dog raincoat comprising:
a multi-part body portion that covers and extends from the back rear end to a head of a dog and the underside of the dog in a concave formation, wherein the underside portion is a removable belly piece that substantially covers the belly and chest of the dog; fastening structures for fastening the body portion to the removable belly piece and securing the dog raincoat to the dog; and a hood that is a waterproof, windproof foldable hood, attached to the top/front body portion of the dog raincoat to cover and uncover the head of the dog.

13. A hood of claim 12, further comprising an external material made of recycled polyester (rPET), a Biopolymer, or any other appropriate waterproof and windproof materials, outlined by a reflective front edge bias binding.

14. A hood of claim 12, further comprising an internal material made of fleece or any other equivalent soft material for the inside of the hood.

15. The dog raincoat of claim 12, further comprising a reflective edge bias binding outlining the front edge of the hood, all edges of the body portion, and all edges of the removable belly piece to increase visibility and safety of the dog.

16. The dog raincoat of claim 12, further comprising a reflective piping between the hood and body portion to increase visibility and safety of the dog.
